(19) United States
(12) Patent Application Publication
(10) Pub. No.: US 2026/0045715 A1
(43) Pub. Date: Feb. 12, 2026

(54) Connector Assembly and Flat Cable

(71) Applicants: Tyco Electronics (Shanghai) Co., Ltd., Shanghai (CN); Tyco Electronics Technology (SIP) Co., Ltd., Suzhou (CN)

(72) Inventors: Ping Wu, Shanghai (CN); Rui (Sage) Zhou, Suzhou (CN); Fuying (Catherina) Zhao, Suzhou (CN); Shanlin Li, Suzhou (CN)

(73) Assignees: Tyco Electronics (Shanghai) Co., Ltd., Shanghai (CN); Tyco Electronics Technology (SIP) Co., Ltd., Suzhou (CN)

(21) Appl. No.: 19/294,872

(22) Filed: Aug. 8, 2025

(30) Foreign Application Priority Data
Aug. 9, 2024 (CN) 202421934658.5

(51) Int. Cl. H01R 12/62; H01R 12/70; H01R 12/72; H01R 13/405; H01R 13/6581; H01R 13/6592

(52) U.S. Cl. CPC H01R 12/62; H01R 12/707; H01R 12/7082; H01R 12/721; H01R 13/405; H01R 13/6581; H01R 13/6592

(57) ABSTRACT

A connector assembly includes a circuit board, a connector, a flat cable, and an insulator. The connector has a housing and a plurality of terminals disposed in the housing. The flat cable has a row of core wires and an inner insulation layer wrapping the row of core wires. A rear end of the plurality of terminals protrude from the housing and are electrically connected to the circuit board. A front end of the row of core wires are exposed from the inner insulation layer and are welded to the circuit board. The insulator is injection-molded onto the circuit board, the rear end of the plurality of terminals, and the front end of the row of core wires through an embedded injection molding process, such that the insulator, the circuit board, the plurality of terminals, and the row of core wires form an integral part.

### CROSS-REFERENCE TO RELATED APPLICATION

This application claims the benefit of the filing date under 35 U.S.C. § 119 (a)-(d) of Chinese Patent Application No. CN202421934658.5 filed on Aug. 9, 2024, the whole disclosure of which is incorporated herein by reference.

### FIELD OF THE INVENTION

The present invention relates to a cable and, more particularly, to a flat cable and a connector assembly including the flat cable.

### BACKGROUND OF THE INVENTION

In the prior art, a wire harness for a Type C connector typically includes a plurality of circular conductors, which need to be welded to a circuit board one by one. Further, each of the circular conductors needs to be clamped and fixed during welding, resulting in a complex welding process and difficulty in automatic production. In addition, the plurality of circular conductors are disorderly bound together, resulting in the disadvantages of large volume and difficulty in identification. In the prior art, each of the circular conductors includes, from the inside to the outside, a core wire, an inner insulation layer, an aluminum foil layer, a braided layer, and an outer insulation layer. Before welding, it is necessary to peel off the outer insulation layer, bend and cut the braided layer, remove the aluminum foil layer, and cut off the inner insulation layer. This results in a complex and time-consuming welding process for the circular conductors, thus reducing production efficiency and increasing manufacturing costs.

### SUMMARY OF THE INVENTION

A connector assembly includes a circuit board, a connector, a flat cable, and an insulator. The connector has a housing and a plurality of terminals disposed in the housing. The flat cable has a row of core wires and an inner insulation layer wrapping the row of core wires. A rear end of the plurality of terminals protrude from the housing and are electrically connected to the circuit board. A front end of the row of core wires are exposed from the inner insulation layer and are welded to the circuit board. The insulator is injection-molded onto the circuit board, the rear end of the plurality of terminals, and the front end of the row of core wires through an embedded injection molding process, such that the insulator, the circuit board, the plurality of terminals, and the row of core wires form an integral part.

### BRIEF DESCRIPTION OF DRAWINGS

The invention will now be described by way of example with reference to the accompanying figures, of which:

FIG. 1 is a perspective view of a connector assembly according to an exemplary embodiment;

FIG. 2 is a partial exploded view of the connector assembly of FIG. 1;

FIG. 3 is another partial exploded view of the connector assembly of FIG. 1;

FIG. 4 is a perspective view of the connector assembly of FIG. 1, in which an outer insulating shell and a rear end cover are removed;

FIG. 5 is a perspective view of an electrical connection module and a shield cover of the connector assembly of FIG. 1;

FIG. 6 is a perspective view of the electrical connection module of FIG. 5 of the connector assembly of FIG. 1;

FIG. 7 is a perspective view of the electrical connection module of FIG. 5 of the connector assembly of FIG. 1, with an insulator not shown;

FIG. 8 is a perspective view of a circuit board and a flat cable of the connector assembly of FIG. 1;

FIG. 9 is an exploded view of the circuit board of FIG. 8 and the flat cable of FIG. 8 of the connector assembly of FIG. 1; and

FIG. 10 is a cross-sectional view of the flat cable of FIG. 8 of the connector assembly of FIG. 1.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

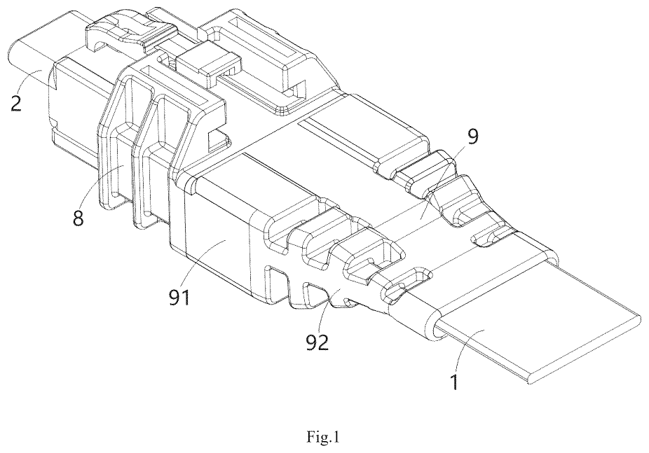

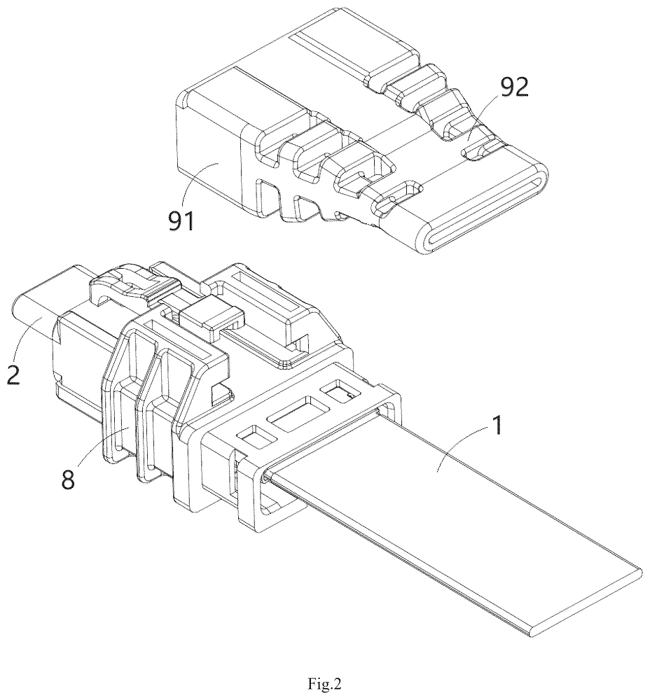

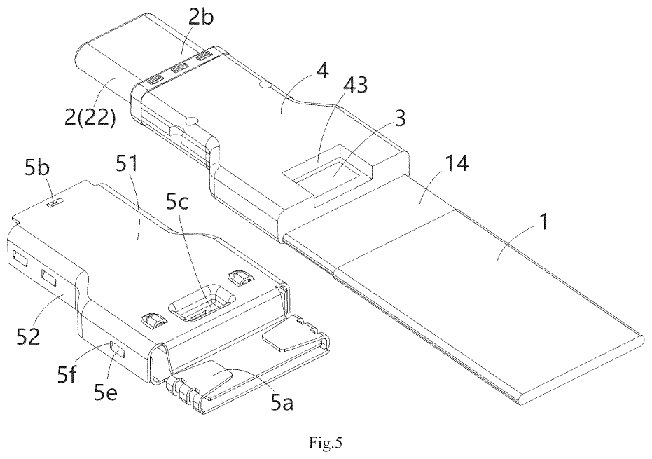

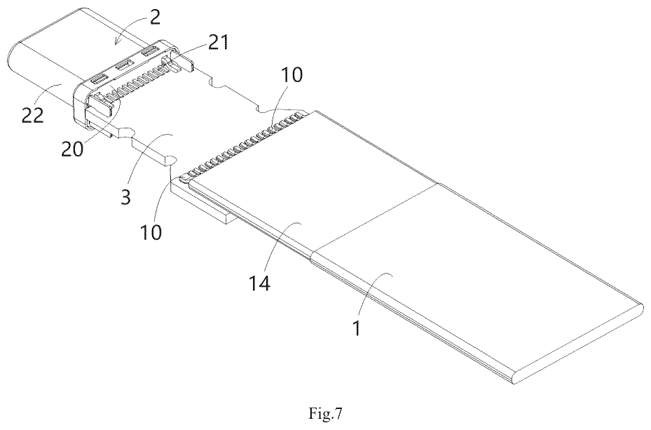

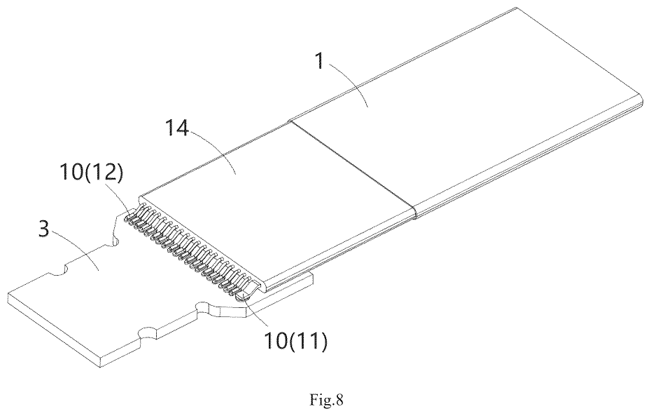

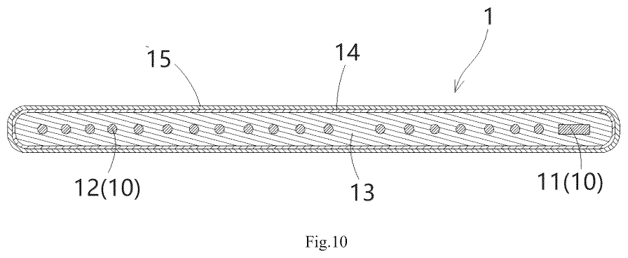

An exemplary embodiment of a connector assembly will now be described with reference to FIGS. 1-10. As shown in FIGS. 5 and 7, the connector assembly includes a flat cable 1, a connector 2, a circuit board 3, and an insulator 4. The connector 2 includes, as shown in FIG. 7, a housing 20 and a plurality of terminals 21 disposed in the housing 20. As shown in FIG. 10, the flat cable 1 includes a row of core wires 10 and an inner insulation layer 13 wrapping the row of core wires 10. As shown in FIG. 7, rear end of the plurality of terminals 21 protrudes from the housing 20 and is electrically connected to the circuit board 3, and front end of the row of core wires 10 is exposed from the inner insulation layer 13 and is welded to the circuit board 3. The insulator 4 is injection-molded onto the circuit board 3, the rear end of the plurality of terminals 21, and the front end of the row of core wires 10 through an embedded injection molding process, such that the insulator 4, the circuit board 3, the plurality of terminals 21, and the row of core wires 10 form an integral part.

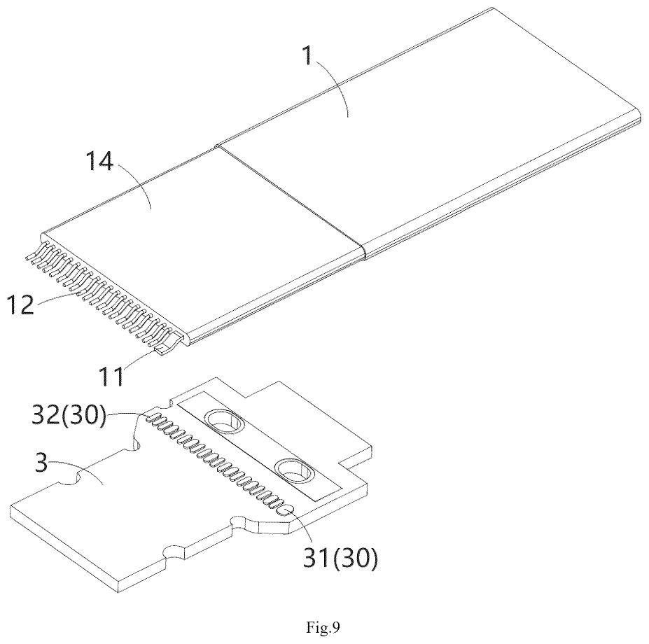

As shown in FIG. 9, a row of pads 30 is formed on the circuit board 3. The front end of the row of core wires 10 of the flat cable 1 is welded to the row of pads 30 of the circuit board 3 respectively.

As shown in FIG. 10, the row of core wires 10 of the flat cable 1 includes a plurality of different types of core wires 10 having different cross-sections and/or sizes. The row of core wires 10 of the flat cable 1 includes a flat core wire 11 having a rectangular cross-section and a circular core wire 12 having a circular cross-section. A width of the flat core wire 11 is greater than a diameter of the circular core wire 12, and a thickness of the flat core wire 11 is equal to the diameter of the circular core wire 12. As shown in FIG. 10, the row of core wires 10 includes a single flat core wire 11 and a plurality of circular core wires 12, and the single flat core wire 11 is a first core wire 10 or a last core wire 10 in the row of core wires 10.

As shown in FIG. 9, the row of pads 30 includes a plurality of different types of pads 30 corresponding to the plurality of different types of core wires 10 respectively. The row of pads 30 includes a first pad 31 corresponding to the flat core wire 11 and a second pad 32 corresponding to the circular core wire 12. A width of the first pad 31 is greater than a width of the second pad 32, and a thickness of the first pad 31 is equal to a thickness of the second pad 32.

As shown in FIG. 7, the plurality of terminals 21 of the connector 2 are arranged in an upper row and a lower row. The rear end of the terminals 21 in the upper row is welded to a front side of the circuit board 3, and the rear end of the terminals 21 in the lower row is welded to a back side of the circuit board 3. In the illustrated embodiment, the connector 2 is a Type-C connector 2 conforming to a Type-C interface standard.

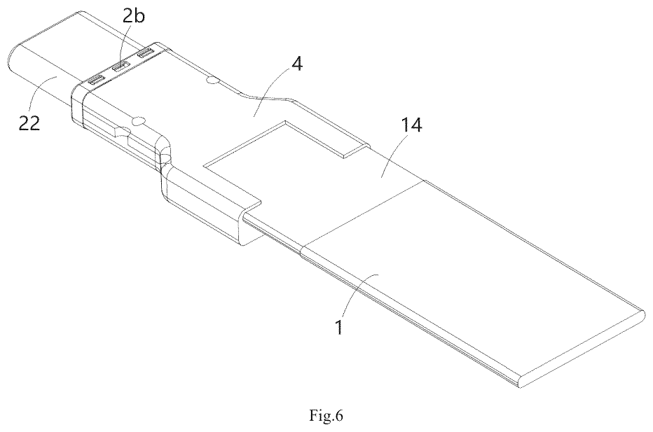

As shown in FIGS. 6-7, the connector 2 further includes a shield case 22 sleeved on the housing 20, and a rear end of the shield case 22 is sleeved and locked to the insulator 4 to fix the connector 2 to a front end of the insulator 4.

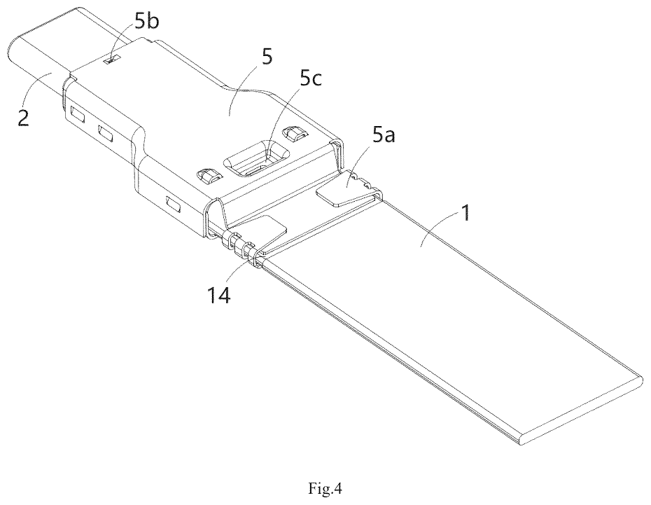

The flat cable 1 further includes a shield layer 14, as shown in FIGS. 4-10, and an outer insulation layer 15, as shown in FIG. 10. As shown in FIG. 10, the shield layer 14 wraps around the inner insulation layer 13, and the outer insulation layer 15 wraps around the shield layer 14.

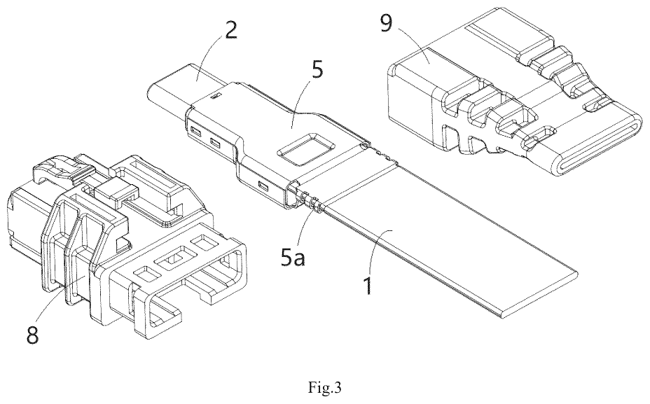

The connector assembly further includes a shield cover 5, as shown in FIGS. 3-5, mounted on the insulator 4. The rear end of the shield case 22 is inserted into a front end of the shield cover 5 and is in electric contact with the front end of the shield cover 5, and a rear end of the shield cover 5 is crimped onto the shield layer 14 of the flat cable 1 that is exposed from the outer insulation layer 15. As shown in FIGS. 3-5, a crimping portion 5a is formed at the rear end of the shield cover 5, and the crimping portion 5a is crimped onto the shield layer 14 of the flat cable 1. An elastic latch 5b, as shown in FIGS. 4-5, is formed on the front end of the shield cover 5, an engagement groove 2b, as shown in FIG. 5, is formed in the rear end of the shield case 22, and the elastic latch 5b is locked into the engagement groove 2b to lock the rear end of the shield case 22 to the front end of the shield cover 5. As shown in FIG. 5, an inwardly protruding contact protrusion 5c is formed on the shield cover 5 and an opening 43 is formed on the insulator 4. A part of the circuit board 3 is exposed from the opening 43, and the contact protrusion 5c of the shield cover 5 is engaged into the opening 43 of the insulator 4 and is in electric contact with the circuit board 3.

As shown in FIG. 5, the shield cover 5 includes an upper shield cover 51 and a lower shield cover 52 assembled together. An elastic piece 5e is formed on a side wall of one of the upper shield cover 51 and the lower shield cover 52 and a snap slot 5f is formed in the other one of the upper shield cover 51 and the lower shield cover 52. The elastic piece 5e is locked into the snap slot 5f to lock the upper shield cover 51 and the lower shield cover 52 together.

As shown in FIGS. 1-3, the connector assembly further includes an outer insulating shell 8. The outer insulating shell 8 is sleeved on the shield cover 5 and has a front port and a rear port opposite each other in an axial direction thereof. The flat cable 1 is led out from the rear port of the outer insulating shell 8, and a part of the connector 2 extends out of the front port of the outer insulating shell 8.

The connector assembly further includes a rear end cover 9, as shown in FIGS. 1-3. The rear end cover 9 is sleeved on the flat cable 1 and is locked onto a rear end of the outer insulating shell 8 to retain the flat cable I to the outer insulating shell 8. The rear end cover 9 includes a fixing portion 91 and a buffer portion 92. The fixing portion 91 is configured to be sleeved and locked onto the rear end of the outer insulating shell 8. The buffer portion 92 extends rearwardly from the fixing portion 91 and is capable of elastic deformation. The flat cable 1 passes through the buffer portion 92, and the buffer portion 92 is configured to provide stress buffer for the flat cable 1 to prevent the flat cable 1 from being damaged by bending.

An exemplary embodiment of the flat cable 1, as shown in FIGS. 1-10, will now be described. As shown in FIG. 10, the flat cable 1 includes the row of core wires 10 and the inner insulation layer 13. The inner insulation layer 13 wraps the row of core wires 10. One end of the row of core wires 10 is exposed from the inner insulation layer 13 and is configured to be welded to a circuit board 3 of a connector assembly. The row of core wires 10 includes a plurality of different types of core wires 10 having different cross-sections and/or sizes. The row of core wires 10, as shown in FIG. 10, includes a flat core wire 11 having a rectangular cross-section and a circular core wire 12 having a circular cross-section.

As shown in FIG. 10, the flat cable 1 further includes a shield layer 14 and an outer insulation layer 15. The shield layer 14 wraps around the inner insulation layer 13. The outer insulation layer 15 wraps around the shield layer 14. One end of the shield layer 14 is exposed from the outer insulation layer 15 and is configured to be electrically connected to a shield cover 5 of the connector assembly.

In the aforementioned various exemplary embodiments according to the present invention, the flat cable 1 has the advantage of small volume, easy handling, and convenient welding, and enables automatic production, thereby improving production efficiency and reducing manufacturing costs. Furthermore, in some of the aforementioned exemplary embodiments according to the present invention, the flat cable 1 further has a shield layer 14, which can ensure the stability of signal transmission of the connector assembly.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “including” or “having” an element or a plurality of elements having a particular property may include additional such elements not having that property.

1. A connector assembly, comprising:
a circuit board;
a connector having a housing and a plurality of terminals disposed in the housing;
a flat cable having a row of core wires and an inner insulation layer wrapping the row of core wires; and
an insulator,
wherein a rear end of the plurality of terminals protrude from the housing and are electrically connected to the circuit board, and a front end of the row of core wires are exposed from the inner insulation layer and are welded to the circuit board, the insulator is injection-molded onto the circuit board, the rear end of the plurality of terminals, and the front end of the row of core wires through an embedded injection molding process, such that the insulator, the circuit board, the plurality of terminals, and the row of core wires form an integral part.

2. The connector assembly of claim 1, wherein a row of pads is formed on the circuit board, the front end of each core wire is welded to one pad of the row of pads.

3. The connector assembly of claim 1, wherein the row of core wires has a plurality of different types of core wires each having different cross-sections and/or sizes, the row of pads has a plurality of different types of pads each respectively corresponding to the plurality of different types of core wires.

4. The connector assembly of claim 1, wherein the row of core wires includes a flat core wire having a rectangular cross-section and a circular core wire having a circular cross-section, the row of pads has a first pad corresponding to the flat core wire and a second pad corresponding to the circular core wire.

5. The connector assembly of claim 4, wherein a width of the flat core wire is greater than a diameter of the circular core wire, a thickness of the flat core wire is equal to the diameter of the circular core wire, a width of the first pad is greater than a width of the second pad, and a thickness of the first pad is equal to a thickness of the second pad.

6. The connector assembly of claim 4, wherein the row of core wires has a single flat core wire and a plurality of circular core wires, the single flat core wire is a first core wire or a last core wire in the row of core wires.

7. The connector assembly of claim 1, wherein the plurality of terminals are arranged in an upper row and a lower row, the rear end of the plurality of terminals in the upper row are welded to a front side of the circuit board, and the rear end of the plurality of terminals in the lower row are welded to a back side of the circuit board.

8. The connector assembly of claim 7, wherein the connector is a Type-C connector conforming to a Type-C interface standard.

9. The connector assembly of claim 1, wherein the connector has a shield case sleeved on the housing, a rear end of the shield case is sleeved and locked to the insulator to fix the connector to a front end of the insulator.

10. The connector assembly of claim 9, wherein the flat cable has a shield layer wrapping around the inner insulation layer and an outer insulation layer wrapping around the shield layer, and the connector assembly further includes a shield cover mounted on the insulator, the rear end of the shield case is inserted into a front end of the shield cover and is in electric contact with the front end of the shield cover, a rear end of the shield cover is crimped onto the shield layer that is exposed from the outer insulation layer.

11. The connector assembly of claim 10, wherein a crimping portion is formed at the rear end of the shield cover, the crimping portion is crimped onto the shield layer.

12. The connector assembly of claim 10, wherein an elastic latch is formed on the front end of the shield cover, an engagement groove is formed in the rear end of the shield case, and the elastic latch is locked into the engagement groove to lock the rear end of the shield case to the front end of the shield cover.

13. The connector assembly of claim 10, wherein an inwardly protruding contact protrusion is formed on the shield cover, an opening is formed on the insulator, a part of the circuit board is exposed from the opening, and the contact protrusion is engaged into the opening of the insulator and in electrical contact with the circuit board.

14. The connector assembly of claim 10, wherein the shield cover has an upper shield cover and a lower shield cover assembled together, an elastic piece is formed on a side wall of one of the upper shield cover and the lower shield cover, a snap slot is formed in the other one of the upper shield cover and the lower shield cover, and the elastic piece is locked into the snap slot to lock the upper shield cover and the lower shield cover together.

15. The connector assembly of claim 10, further comprising an outer insulating shell sleeved on the shield cover and having a front port and a rear port opposite each other in an axial direction of the outer insulating shell, the flat cable is led out from the rear port of the outer insulating shell, and a part of the connector extends out of the front port of the outer insulating shell.

16. The connector assembly of claim 15, further comprising a rear end cover sleeved on the flat cable and locked onto a rear end of the outer insulating shell to retain the flat cable to the outer insulating shell.

17. The connector assembly of claim 16, wherein the rear end cover has a fixing portion locked onto the rear end of the outer insulating shell and a buffer portion elastically deformable and extending rearwardly from the fixing portion, the flat cable passes through the buffer portion, and the buffer portion provides a stress buffer for the flat cable to prevent the flat cable from being damaged by bending.

18. A flat cable, comprising:
a row of core wires; and
an inner insulation layer wrapping the row of core wires, one end of the row of core wires is exposed from the inner insulation layer and is welded to a circuit board of a connector assembly, the row of core wires has a plurality of different types of core wires having different cross-sections and/or sizes.

19. The flat cable of claim 18, wherein the row of core wires includes a flat core wire having a rectangular cross-section and a circular core wire having a circular cross-section.

20. The flat cable of claim 18, further comprising a shield layer wrapping around the inner insulation layer and an outer insulation layer wrapping around the shield layer, one end of the shield layer is exposed from the outer insulation layer and is electrically connected to a shield cover of the connector assembly.
